(19) United States
(12) Patent Application Publication
(10) Pub. No.: US 2007/0242863 A1
(43) Pub. Date: Oct. 18, 2007

(54) Methods and Apparatus for Contouring at Least One Vessel

(76) Inventors: Bernice Eland Hoppel, Delafield, WI (US); Tracy Quayle Callister, Hendersonville, TN (US)

Correspondence Address: FISHER PATENT GROUP, LLC, 700 6TH STREET NW, HICKORY, NC, 28601, US

(21) Appl. No.: 11/561,110

(22) Filed: Nov. 17, 2006

Related U.S. Application Data
(63) Continuation-in-part of application No. 11/403,656, filed on Apr. 13, 2006.

(51) Int. Cl. G06K 9/00

(52) U.S. Cl. 382/128

(57) ABSTRACT

A method includes accessing image data regarding at least one vessel, and contouring the at least one vessel by defining a plurality of components of a histogram.

### CROSS-REFERENCE TO RELATED APPLICATIONS

This application is a continuation-in-part (CIP) of application Ser. No. 11/403,656 filed Apr. 13, 2006.

### BACKGROUND OF THE INVENTION

This invention relates generally to methods and apparatus for Diagnostic Imaging (DI), and more particularly to methods and apparatus that provide for the ability to contour at least one vessel.

There appears to be increasing awareness of the importance of composition of athero-thrombotic plaque as a major risk factor for acute coronary syndromes. Both invasive and noninvasive imaging techniques are available to facilitate the assessment of athero-thrombotic vessels.

An unstable plaque or soft plaque rupture can be an unhealthy condition in which a formation of plaque within an artery or other vessel ruptures, releasing fatty particles and other poisons into the bloodstream. Furthermore, the site of rupture could seal over, causing a potentially larger blockage in the artery or other vessel.

The physician should understand the components of the cardiac disease, that presents in the patient because some components such as calcium are less likely then other components to become vulnerable and break off from the vessel, and possibly create a stroke or sudden death. The detection of a plaque's morphological characteristics can provide support for early diagnosis or a more efficient treatment plans, such as differentiating between a surgical treatment or an aggressive pharmaceutical treatment. Calcified plaques are less likely to become vulnerable and therefore, unless the vessel is near complete stenosis, the calcified plaques can be treated pharmaceutically in many cases.

The current standard technique for the detection and evaluation of coronary artery disease was contrast angiography. However, recently a number of limitations of contrast angiography have become apparent. The limitations include an absence of information about the blood vessel wall, insensitivity to substantial plaque burden in outwardly remodeled vessels, and an inability to detect vessel wall disruptions during angioplasty.

### BRIEF DESCRIPTION OF THE INVENTION

In one aspect, a method is provided. The method includes accessing image data regarding at least one vessel, and contouring the at least one vessel by defining a plurality of components of a histogram.

In another aspect, a method of segmenting tissue of an organ is provided. The method includes accessing image data from an imaging modality acquisition system wherein the image data includes at least one of a three dimensional single or multiple cardiac phase dataset and/or a three dimensional multi-temporal phase dataset of a feature of interest in an organ or tissue, wherein the data is acquired in conjunction with or without at least one of an imaging agent, blood, a contrast agent, and a biomedical agent, wherein the data can be acquired in a state of cardiac stress or in non-cardiac stress state; wherein segmentation is performed on the data by using a method which includes histogram analysis by classification of elements of vascular tissue as one of epicardial fat, calcium, lumen/contrast, and fatty plaque/thrombus of the data into different densities through the use of a line fitting technique on the histogram, where each element defines the outer wall of the vessel.

In still another aspect, apparatus includes a detector, and a computer operationally coupled to the detector. The computer is configured to access image data regarding at least one vessel, and contour the at least one vessel by defining a plurality of components of a histogram.

### BRIEF DESCRIPTION OF THE DRAWINGS

FIG. 1 illustrates an imaging modality acquisition system with an associated display.

FIG. 2 illustrates that some vessels may not have contrast throughout the lumen.

FIG. 3 illustrates a three dimensional tube around the right coronary vessel.

FIG. 4 illustrates a histogram with lines or cut offs that are used to classify elements.

FIG. 5 illustrates a method.

### DETAILED DESCRIPTION OF THE INVENTION

There are herein provided clustering and classification methods and apparatus useful for imaging systems such as, for example, but not limited to a Computed Tomography (CT) System. The apparatus and methods are illustrated with reference to the figures wherein similar numbers indicate the same elements in all figures. Such figures are intended to be illustrative rather than limiting and are included herewith to facilitate explanation of an exemplary embodiment of the apparatus and methods of the invention. Although, described in the setting of CT, it is contemplated that the benefits of the invention accrue to all DI modalities including Magnetic Resonance Imaging (MRI), Positron Emission Tomography (PET), Electron Beam CT (EBCT), Single Photon Emission CT (SPECT) , Ultrasound, optical coherence tomography, etc., as well as yet to be invented modalities.

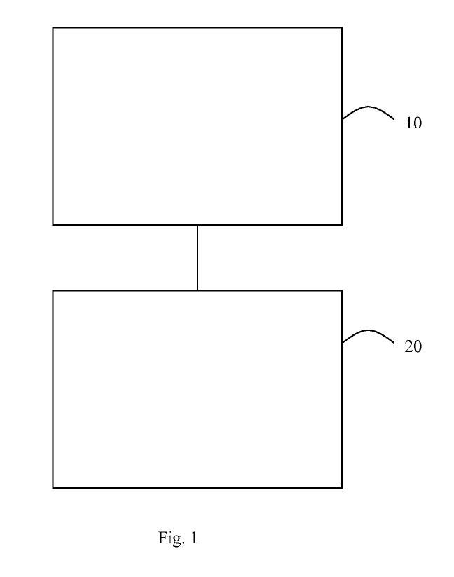

FIG. 1 illustrates an imaging modality acquisition system 10 with an associated display 20. Imaging system 10 can be of any modality, but in one embodiment, system 10 is a CT system. In another embodiment, system 10 is a dual modality imaging system such as a combined CT/PET system and the below described clustering and statistical methods can be done in one modality (e.g., CT) and the processed data can be transferred to the other modality (e.g., PET). Display 20 can be separate from system 10 or integrated with system 10. System 10 includes an acquisition device such as an x-ray radiation detector, a Gamma Camera, and/or an ultrasound probe or RF Coil. Note that in CT, EBCT, and ultrasound the acquisition device receives energy transmitted through the patient, but in PET and SPECT, the acquisition device receives energy emitted from the patient. In MRI, energy is transmitted and a passive signal from this is received. Common to all modalities is that an acquisition device receives energy regarding the patient or other scanned object.

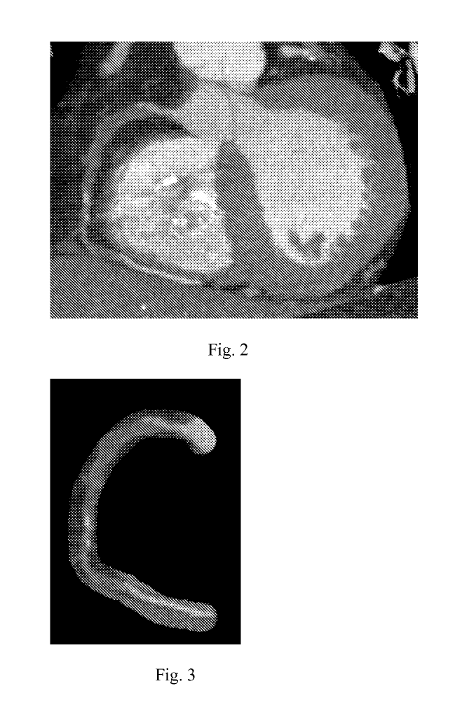

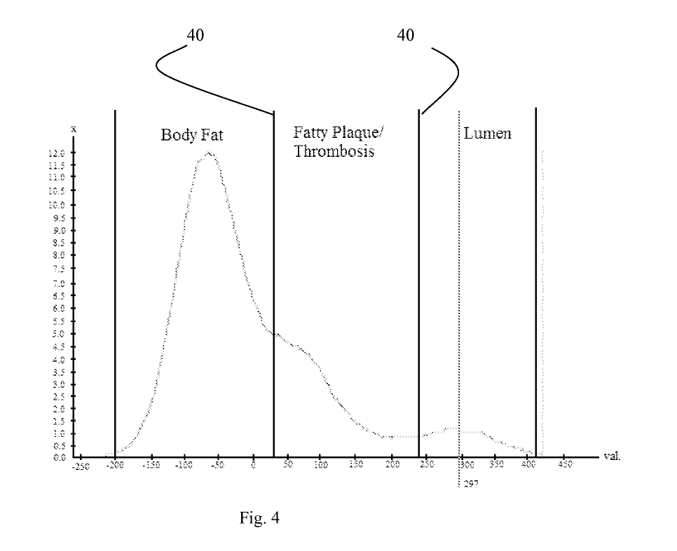

When looking at coronaries, it is desirable to have an outline of the vessels, although some vessels may not have contrast throughout the lumen such as the one found in FIG. 2. More particularly, FIG. 2 illustrates a right coronary artery (RCA) that has become thrombosed. Note that contrast no longer flows through the vessel and that the inferior portion of the vessel is being supplied via collateral flow. If one draws a three dimensional tube around the right coronary vessel as shown in FIG. 3, one can produce a histogram containing the components (also referred to herein as elements) of the vessel. FIG. 4 illustrates that the histogram of the image provides valuable data within it.

In one embodiment, four components are desired to be classified and displayed to facilitate the diagnosis or treatment of vascular disease. The four components or elements are 1 lumen, 2 body fat, 3 thrombosis/fatty plaques, and 4 calcium. The fatty plaques and thrombosis will be considered as one single component. With the onset of multi-energy CT imaging, one may be further able to analyze these components. Therefore, they may be able to be differentiated and other embodiments could use more than four components or less than four. For example, one embodiment uses only three components, the ones listed above as 1-3, and calcium is not used. A histogram of the region of interest is acquired as shown in FIG. 3. This particular histogram does not include the calcium peak. Utilizing a method of mixture of Gaussians with four possible peaks, one is able to get an initial estimate of the mean and standard deviation of each of these peaks. An expectation maximization technique was used. The expectation-maximization technique is a maximum likelihood technique for finding estimates of parameters by using probabilistic models of unobservable parameters. The routine used alternated between using an expectation step and a maximization step, which computed the maximum likelihood estimates for each parameter. The expectation part of this algorithm is described in equation 1, where x represents the Gaussian models and y are the samples taken from each model. The model we are trying to estimate is represented by t. We estimate this model and with means and standard deviations.

$$P ( {x}_{i} \vert {y}_{j} , t ) = \frac{p ( {y}_{j} \vert {x}_{i} , t ) P ( {x}_{i} \vert t )}{{\sum }_{k = 1}^{n} p ( {y}_{j} \vert {x}_{k} , t ) P ( {x}_{k} \vert t )} \qquad Equation 1$$

Where P is probabilities vector for each sample and each model (x), and n ranges from 1 to 4 dependent on the Gaussian model The maximization function given in equation 2 which will determine the estimates in the next estimation step.

$$P ( {x}_{i} \vert t ) = \frac{{\sum }_{j = 1}^{m} P ( {x}_{i} \vert {y}_{j} , t )}{{\sum }_{i = 1}^{n} {\sum }_{j = 1}^{m} P ( {x}_{i} \vert {y}_{j} , t )} \qquad Equation 2$$

The mean and the standard deviation can then be calculated and a new distribution (t) can be defined. The iterative process continues until a maximum logarithmic likelihood has been reached and the difference between the steps is less than 10%. This method will give a list of four possible means and standard deviations for the different peaks in the four-component example.

However, because of some skewed data, this method may not find the center of the distribution, which is the value which is important to us, Therefore, one can use a maximization function and smaller range of sample points to increase the accuracyAdditionally, to improve the accuracy of this a least squares fit of the Gaussian distribution may be performed.

Once again the Gaussian distribution can be used, although another distribution like the log-normal or Rayleigh distribution could be used,

$$y ( x ) = \frac{1}{σ \sqrt{2 π}} exp ( - \frac{{( x - μ )}^{2}}{2 {σ}^{2}} ) \qquad Equation 3$$

The mean (μ) and the sigma (σ) can be fit by minimizing the square of the distance between the calculated y-values for the expression and that of the actual y-data.

The distribution of the components overlap each other so it is desirable to define the edges of each distribution more completely, especially the plaque/thrombosis which is defined as the region between the lines labeled 40 in FIG. 4. Therefore, it is necessary to use a more sophisticated technique such as fuzzy clustering or nearest neighbors to place pixels in each element. Note this is patient specific. The lines 40 could be different for another patient. In FIG. 4, the x-axis is CT numbers while the y-axis is the number of pixels with that particular CT number. For example, at around −75 HU is where the peak number of pixels is with 12 pixels in the image having the −75 value.

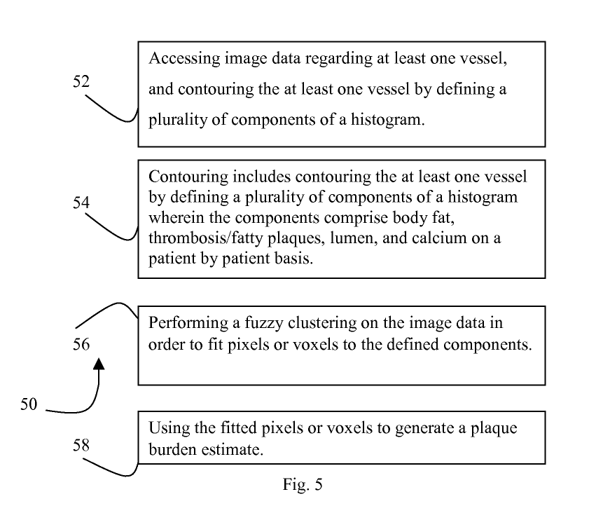

FIG. 5 illustrates a method 50 including accessing image data regarding at least one vessel, and contouring the at least one vessel by defining a plurality of components of a histogram at step 52. Optionally, method 50 includes contouring at least one vessel by defining a plurality of components of a histogram wherein the components comprise body fat, thrombosis/fatty plaques, lumen, and calcium on a patient by patient basis at step 54. In addition, method 50 includes in one embodiment, performing a method of clustering, such as fuzzy clustering, on the image data in order to fit pixels or voxels to the defined components at step 56. Also optional is step 58 that includes using the fitted pixels or voxels to generate a plaque burden estimate.

Cluster analysis divides data into groups (clusters) such that similar data objects (those of similar signal intensity) belong to the same cluster and dissimilar data objects to different clusters. The resulting data partition improves data understanding and reveals its internal structure. Partitional clustering algorithms divide a data set into clusters or classes, where similar data objects are assigned to the same cluster whereas dissimilar data objects should belong to different clusters.

$$J = {\sum }_{i = 1}^{c} {J}_{t} = {\sum }_{i = 1}^{c} ( {\sum }_{k , {u}_{k} {C}_{i}} {‖ {u}_{k} - {c}_{t} ‖}^{2} ) \qquad Equation 4$$

where c=number of clusters, and u=distance of a pixel from cluster centroid.

The membership of a pixel or voxel in a cluster is decided as follows using K-means:

$${m}_{sk} = \{ \begin{matrix}1 & if {‖ {u}_{k} - {c}_{i} ‖}^{2} \leq {‖ {u}_{k} - {c}_{j} ‖}^{2} \\ 0 & otherwise\end{matrix} \} \qquad Equation 5$$

The problem with using a simplistic method (like K-means analysis) is that choosing the initial centroids of the cluster will determine the outcome.

In medical applications there is very often no sharp boundary between clusters so that fuzzy clustering is often better suited for the data. Membership degrees between zero and one are used in fuzzy clustering instead of crisp assignments of the data to clusters. Fuzzy clustering allows one to calculate a membership function for which each pixel can belong. Each pixel is assigned a value to each cluster somewhere between zero and 1. The object of the clustering is to minimize the distance between each point and the centroid of the cluster. This is done through an iterative method as described in the equations below.

$$\begin{matrix}{J}_{m} = {\sum }_{i = 1}^{N} {\sum }_{j = 1}^{c} {u}_{ij}^{m} {‖ {x}_{i} - {c}_{j} ‖}^{2} & Equation 6 \\ {u}_{ij} = \frac{1}{{\sum }_{k = 1}^{c} {( \frac{‖ {x}_{i} - {c}_{j} ‖}{‖ {x}_{i} - {c}_{k} ‖} )}^{\frac{2}{( m - 1 )}}} where {c}_{j} = \frac{{\sum }_{i = 1}^{N} {u}_{ij}^{m} {x}_{i}}{{\sum }_{i = 1}^{N} {u}_{ij}^{m}} & Equation 7\end{matrix}$$

Once a minimum distance is reached, the maximum coefficients of each pixel can be displayed as an image.

$$max \{ \vert {u}_{ij}^{k} - {u}_{ij}^{k} \vert \} < ɛ 0 < ɛ < 1 where k = iteration steps \qquad Equation 8$$

This fuzzy cluster or another type of clustering can be used to separate the pixels greater than one or two standard deviation away from the mean of the lumen or body fat. These initial values will help contour the vessels since the vessel, which does not have contrast all the way through it like the one shown in FIG. 2, will not be contoured correctly with the standard K-means analysis.

This method minimizes the distance between the pixels of the same components. The pixels on the outside of the vessel wall will be considered part of the plaque/ thrombosis which is satisfactory because the thicker the wall layer the more likely the patient has athero-thrombotic disease.

Therefore, once the components are defined that surround the vessel, such as the body fat, and the internal components such as the contrast within the lumen. It is easy to define the remaining component of fatty plaque/thrombosis. This allows one to improve the characterization of the disease within the vessel.

As used herein, the phrase “reconstructing an image” is not intended to exclude embodiments of the present invention in which data representing an image is generated but a viewable image is not. Therefore, as used herein the term, “image,” broadly refers to both viewable images and data representing a viewable image. However, many embodiments generate (or are configured to generate) at least one viewable image.

In one embodiment, system 10 includes a device for data storage, for example, a floppy disk drive, CD-ROM drive, DVD drive, magnetic optical disk (MOD) device, or any other digital device including a network connecting device such as an Ethernet device for reading instructions and/or data from a computer-readable medium, such as a floppy disk, a CD-ROM, a DVD or an other digital source such as a network or the Internet, as well as yet to be developed digital means. In another embodiment, the computer executes instructions stored in firmware (not shown). Generally, a processor is programmed to execute the processes described herein. Of course, the methods are not limited to practice in CT and system 10 can be utilized in connection with many other types and variations of imaging systems. In one embodiment, the computer is programmed to perform functions described herein, accordingly, as used herein, the term computer is not limited to just those integrated circuits referred to in the art as computers, but broadly refers to computers, processors, microcontrollers, microcomputers, programmable logic controllers, application specific integrated circuits, and other programmable circuits. Additionally, the computer is operationally coupled to the acquisition device. Although the herein described methods are described in a human patient setting, it is contemplated that the benefits of the invention accrue to non-human imaging systems such as those systems typically employed in small animal research.

Technical effects include the ability to accurately define the components of vascular plaque relatively quickly while also being able to accurately define the edges of the vessels. This will also allow one to define a plaque burden for each patient.

Exemplary embodiments are described above in detail. The assemblies and methods are not limited to the specific embodiments described herein, but rather, components of each assembly and/or method may be utilized independently and separately from other components described herein.

While the invention has been described in terms of various specific embodiments, those skilled in the art will recognize that the invention can be practiced with modification within the spirit and scope of the claims.

What is claimed is:

1. A method comprising:
accessing image data regarding at least one vessel; and
contouring the at least one vessel by defining a plurality of components of a histogram.

2. A method in accordance with claim 1 wherein said contouring comprises contouring the at least one vessel by defining a plurality of components of a histogram wherein the components comprise body fat and thrombosis/fatty plaques.

3. A method in accordance with claim 1 wherein said contouring comprises contouring the at least one vessel by defining a plurality of components of a histogram wherein the components comprise body fat, thrombosis/fatty plaques, lumen, and calcium.

4. A method in accordance with claim 2 further comprising performing a clustering method on the image data in order to fit pixels or voxels to the defined components.

5. A method in accordance with claim 4 further comprising using the fitted pixels or voxels to generate a plaque burden estimate.

6. A method in accordance with claim 2 wherein the body fat comprises epicardial fat.

7. A method in accordance with claim 1 wherein said contouring comprises contouring the at least one vessel by defining a plurality of components of a histogram on a patient-by-patient basis.

8. A method of segmenting tissue of an organ, said method comprising: accessing image data from an imaging modality acquisition system wherein the image data comprises at least one of a three dimensional single or multiple cardiac phase dataset and/or a three dimensional multi-temporal phase dataset of a feature of interest in an organ or tissue, wherein the data is acquired in conjunction with or without at least one of an imaging agent, blood, a contrast agent, and a biomedical agent, wherein the data can be acquired in a state of cardiac stress or in non-cardiac stress state; wherein segmentation is performed on the data by using a method which includes histogram analysis by classification of elements of vascular tissue as one of epicardial fat, calcium, lumen/contrast, and fatty plaque/thrombus of the data into different densities through the use of a line fitting technique on the histogram, where each element defines the outer wall of the vessel.

9. A method in accordance with claim 8 further comprising performing a definition of transition regions between elements.

10. A method in accordance with claim 8 further comprising using a fuzzy clustering technique to determine a pixel's or voxel's membership status in a region.

11. A method in accordance with claim 8 wherein said performing comprises at least one of a statistical analysis or line fitting technique to divide the histogram or densities of the 3D dataset as a mixture of Gaussians technique, expectation maximization, probabilistic method, least squares fit, polynomial fit method to determine the different densities of each component to define the mean or average value of the element and standard deviation or spread of each element.

12. A method in accordance with claim 9 wherein said performing a definition of borders or transitional areas between elements comprises at least one of a multivariate analysis, a classifier based analysis, an exclusive clustering algorithm, an overlapping and fuzzy clustering algorithm, a partitioning algorithm, a probabilistic clustering, a hierarchical clustering, a K-means analysis, a fuzzy C-means analysis, an expectation maximization analysis, a density based algorithm, a grid-based algorithm and a model based algorithm and combinations thereof.

13. A method in accordance with claim 8 further comprising performing a visualization of the elements from analysis represented as discrete colors fused with a colorized or transparent view of the vessel which they are part of.

14. A method in accordance with claim 8 wherein the imaging modality acquisition system is one of a single energy CT system and a multi-energy CT system.

15. A method in accordance with claim 8 wherein the histograms analysis is done on a patient-by-patient basis.

16. Apparatus comprising:
a detector; and
a computer operationally coupled to said detector, said computer configured to:
access image data regarding at least one vessel; and
contour the at least one vessel by defining a plurality of components of a histogram.

17. Apparatus in accordance with claim 16 wherein the contouring comprises contouring the at least one vessel by defining a plurality of components of a histogram were wherein the components comprise body fat, and thrombosis/fatty plaques.

18. Apparatus in accordance with claim 17 wherein the contouring further comprises contouring the at least one vessel by defining a plurality of components of a histogram wherein the components comprise body fat, thrombosis/fatty plaques, lumen, and calcium.

19. Apparatus in accordance with claim 16 wherein said computer further configured to perform a fuzzy clustering on the image data in order to fit pixels or voxels to the defined components.

20. Apparatus in accordance with claim 19 wherein said computer further configured to use the fitted pixels or voxels to generate a plaque burden estimate.
